(19) United States
(12) Patent Application Publication
(10) Pub. No.: US 2009/0321416 A1
(43) Pub. Date: Dec. 31, 2009

(54) ENHANCED ENERGY DELIVERY MECHANISM FOR BULK SPECIALTY GAS SUPPLY SYSTEMS

(76) Inventors: Christos Sarigiannidis, Williamsville, NY (US); Thomas John Bergman, JR., Clarence Center, NY (US); Michael Clinton Johnson, Clarence Center, NY (US); Jerry Michael Mahl, (US); Judy Donelli, Youngstown, NY (US); Shrikar Chakravarti, East Amherst, NY (US); Heng Zhu, Tonawada, NY (US); Kenneth Leroy Burgers, East Amherst, NY (US); Justin Cole Germond, Ameherst, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 12/147,848

(22) Filed: Jun. 27, 2008

(51) Int. Cl. H05B 3/06; H05B 3/20; F17C 13/00; F17C 7/04

(52) U.S. Cl. 219/535; 219/536; 219/521; 62/48.1

(57) ABSTRACT

A system for delivering vapor phase fluid at an elevated pressure from a transport vessel containing liquefied or two-phase fluid is provided. The system includes: (a) a transport vessel positioned in a substantially horizontal position; (b) one or more energy delivery devices disposed on the lower portion of the transport vessel wherein the energy delivery devices include a heating means and a thermally conductive non-adhesive layer disposed therebetween to the gaps and provide substantially uniform energy to the transport vessel.

### BACKGROUND OF THE INVENTION

1. Field of the Invention

The present invention relates to an enhanced energy delivery mechanism which can be employed with bulk specialty gas supply systems. These systems involve any number of large scale transport vessels to deliver fluid to a semiconductor, light emitting diode, liquid crystal display or photovoltaics manufacturer. In particular, the energy delivery mechanism is an external, removable device which conforms to the vessel wall surface to deliver energy in an efficient manner.

2. Description of Related Art

Industrial processing and manufacturing applications such as semiconductor, light emitting diode (LED), liquid crystal display (LCD) manufacture and photovoltaics (PV) require processing steps which employ one or more non-air fluids. It will be understood by those skilled in the art that “non-air” fluids or gases refer to fluids (in various phases) which are not derived from the constituent components of air. As utilized herein, non-air fluids or gases include, but are not limited to, ammonia, boron trichloride, carbon dioxide, chlorine, dichlorosilane, halocarbons, hydrogen fluoride etc. Specifically, the manufacture requires the application of non-air gases in vapor phase.

Generally, gases are delivered to the manufacturer's facility in a bulk specialty gas system which includes one or more transport vessel. Fluid is removed from this vessel in vapor phase and delivered to the point-of-use in a discontinuous manner.

The ultimate application requires that the vapor phase gas contain a relatively low level of low volatility contaminants, as otherwise these contaminants can deposit on the product substrate (e.g., semiconductor wafer, LCD motherglass or LED sapphire base and PV substrates). Deposition of these low volatility contaminants, which include water, metal and particulates, can produce a number of deleterious effects, including reduced brightness (LED manufacture) and yield loss (semiconductor, LCD, or PV manufacture).

Fluids such as silane and nitrogen trifluoride are delivered and stored in vapor phase. Since low volatility components do not evaporate readily, their concentration in these fluids is typically low. Other non-air fluids or gases are transported and stored as liquids or vapor/liquid mixtures. These gases are commonly known as low vapor pressure gases, and include, for example, ammonia, hydrogen chloride, hydrogen fluoride, carbon dioxide, and dichlorosilane. These fluids typically have a vapor pressure of less than 1,500 psig at a temperature of 70° F. A complex mechanism is necessary to deliver these latter gases to the point-of-use in vapor phase at the requisite purity, since the conversion of stored liquid low vapor pressure gases into vapor tends to cause the low volatility contaminants to vaporize.

One of the critical issues associated with the bulk gas supply systems is the delivery of energy in the form of heat to the vessel wall in such a manner as to avoid nucleate boiling. As used herein, the term “nucleate boiling” connotes a vigorous boiling regime of the liquid phase low vapor pressure fluid. Such boiling can cause liquid droplets containing low volatility contaminants to be entrained and carried into the vapor phase.

Several energy delivery mechanisms have been proposed in the related art for bulk gas supply systems. Some mechanisms involve internal heating devices mounted within the bulk gas supply vessel, while others call for external heating devices or a mixture thereof for controlling the energy input and the vaporization of the liquid fluid contained in the vessels.

U.S. Pat. No. 5,673,562 to Friedt discloses an internal heat exchanger which functions to maintain the temperature of the liquid-gas interface inside the container essentially constant, while the external heat exchanger functions primarily to preheat the gas. The internal heat exchange is physically located in the inner part of the container, above the liquid fluid.

U.S. Pat. No. 6,025,576 to Beck et al teaches an external heater skid with built-in heating elements for heating and supporting a compressed-gas dispensing bulk vessel. The skid incorporate the features required for handling a cylinder while also providing a means for heating the cylinder in a controlled manner.

U.S. Pat. No. 6,581,412 B2 to Pant et al, and assigned to the owner of the present application, is directed to a method for delivering a liquefied compressed gas with a high flow rate, including inter alia, external heating means positioned proximate to the storage vessel. The heat output of the heating means is adjusted to heat the liquefied compressed gas in order to control the evaporation of the liquefied gas contained therein.

Some of the disadvantages related to the internal heating mechanisms of the related art is that internal heating requires the devices to be installed during the container manufacture process. This not only complicates the container manufacture process, but it causes maintenance difficulties, and reduces the flexibility for further improvement and upgrade of the heating means. In addition, internal heating means usually have heat transfer devices in direct contact with the liquefied gas. This would add an extra possible source of gas contamination, which could be due to the impurities detached from the heat transfer devices, or due to a leak of the heat transfer media contained inside such devices.

On the other hand, external heating mechanisms found in conventional bulk supply systems do not conform to the contour of the vessel's surface and result in an uneven or nucleate boiling. Heating mechanisms consisting of malleable heaters, such as silicon rubber heating bands held in tension contact with the vessel wall results in local air gaps due to the irregularities of the surfaces of the heating bands and/or the vessel. The air gaps, further contribute to the formation of local hot spots on the heating bands, which deleteriously affect the performance and safety of the bulk gas supply system.

Although fluid bath heating mechanisms would conform to the vessel surface, regardless of the surface irregularities, these mechanisms raise other technical and maintenance problems. For example, when the required heating power increases, it is possible for the fluid to develop nucleate boiling, in which case the heat transfer is reduced. In addition, in the case of large gas vessels/containers such as ISO containers, the fabrication, control and maintenance issues of fluid bath may be even more complicated.

To overcome the disadvantages of the conventional systems described above, it is an object of the present invention to provide an efficient energy delivery mechanism for a transport/storage vessel, such as a drum, ton or ISO container utilized in a bulk gas supply system, where the external heating device is placed on the surface of the vessel in a manner which substantially reduces the air gaps therebetween.

It is another object of the invention, to provide a system for delivering vapor phase fluid at an elevated pressure from the transport/storage vessel, where the energy delivery devices are configured and held in contact with the vessel wall so as to efficiently deliver energy to the vessel. In particular, the energy delivery devices are held in close contact with the wall of the transport/storage vessel, and substantially eliminates the uneven distribution of energy. In addition, the life span of the energy delivery devices is increased.

It is yet another object of the invention, to provide an energy delivery device that is adapted to be removed and utilized on various transport/storage vessels. Moreover, the energy delivery devices can readily be removed and replaced in the event of failure.

It is another object of the invention to provide an energy delivery device designed to increase the energy delivered to transport/storage vessel, which leads to higher gas delivery flow rate, while maintaining the purity required at the point-of-use.

Other objects and aspects of the present invention will become apparent to one of ordinary skill in the art upon review of the specification, drawings and claims appended hereto.

### SUMMARY OF THE INVENTION

According to an aspect of the invention, an energy delivery mechanism for a transport vessel utilized to convey vapor phase fluid at an elevated pressure is provided. The mechanism includes at least one energy delivery device disposed on the lower portion of a transport vessel including a thin layer of a thermally conductive non-adhesive layer in contact with vessel wall, at least one heating element which substantially conforms to the contour of the vessel wall, and a thermal interface material disposed between the thermally conductive non-adhesive layer and the heating element, wherein the thermal interface material substantially fills the gaps between the unmatching configuration of the transport vessel and the heating element thereby providing substantially uniform energy to the transport vessel.

In accordance with another aspect of the invention, an efficient energy delivery system adapted to various cylindrical transport vessels is provided. The system includes (a) a crescent-shaped substantially rigid cradle to accommodate a horizontally placed cylindrical transport vessel; and (b) at least one energy delivery device disposed on the lower portion of said transport vessel including a thin layer of a thermally conductive non-adhesive layer in contact with vessel wall, a heating element which substantially conforms to the contour of the vessel wall, and a thermal interface material disposed between the thermally conductive non-adhesive layer and the heating element, wherein the thermal interface material substantially fills the gaps between the unmatching configuration of the transport vessel and the heating element thereby providing substantially uniform energy to the transport vessel.

### BRIEF DESCRIPTION OF THE FIGURES

The objects and advantages of the invention will be better understood from the following detailed description of the exemplary embodiments thereof in connection with the accompanying figures wherein like numbers denote same features throughout and wherein:

FIG. 1 is a schematic illustration of a transport vessel with an external energy delivery mechanism;

FIG. 2(a) illustrates an exemplary embodiment of a system for delivering vapor phase fluid with an energy delivery mechanism including a thermal interface material which fills the gaps between the cradle and the transport vessel;

FIG. 2(b) is a graphical illustration of the thermal interface material filling the gap between the unmatching surface curvatures of the cradle and the transport vessel; and

FIG. 3 illustrates the comparative gas delivery flow between a ton container with the conventional heating mechanism and the one of the present invention.

### DETAILED DESCRIPTION OF THE INVENTION

The manufacture of semiconductor devices, LEDs, LCDs and solar/photovoltaic cells requires the delivery of vapor phase, low vapor pressure gases to a point-of-use. These fluids must meet customer purity and flow requirements. The present invention provides an enhanced energy delivery mechanism for a bulk specialty gas supply system, employed in the transportation of a compressed gas for delivery to a semiconductor or LED manufacturer. The compressed gas is delivered as a low vapor pressure vapor stream which is lean in low volatility contaminants to the point-of-use, typically at the manufacture site. As utilized herein, the term “lean” shall mean a vapor stream having a lower level of low volatility contaminants therein than the liquid or two-phase fluid provided by the gas manufacturer. The system provides the requisite purity on a consistent basis. Further, the transport/storage vessel (referred below, as the transport vessel), which is part of the bulk specialty gas supply system, is preferably designed to carry more than about 500 lbs. and preferably between 20,000 and 50,000 lbs. of low vapor pressure fluid. Additionally, it is preferable that the vessel be capable of being shipped, and is compliant with International Standards Organization (ISO) requirements (e.g., ISO container standards). Such transport vessel, will be understood by those skilled in the art, to include a cylinder, a drum, or a ton container or an ISO container.

Typically, low vapor pressure non-air fluids are stored in a transport vessel under their own vapor pressure. While the fluid contained in the transport vessel delivered to the point-of-use is process dependent, for ease of reference ammonia is utilized as the fluid of choice, but it will be understood that any number of low vapor pressure non-air fluids may be utilized. The transport vessel can be constructed from a material such as carbon steel, type 304 and 316 stainless steel, Hastelloy, nickel or a coated metal (e.g., a zirconium-coated carbon) which is strictly non-reactive with the fluids utilized and can withstand both a vacuum and high pressures.

The transport vessel, such as an ISO container, is installed “on-site,” that is in close proximity to the manufacturing facility and may be installed outdoor, where the temperature can be as low as −30° C., or indoor. The manufacturing facility is preferably equipped with automatic gas sensors and an emergency abatement system in case of an accidental leakage or other malfunctions of the system.

The transport vessel can be insulated, partially insulated or not insulated at all. As a result, the temperature of the transport vessel contents during transport and storage at the facility can be similar to ambient temperature. For example, at a temperature of 50° F., the pressure in the transport vessel is approximately 89.2 psia. One of the issues associated with conventional systems is that away from the contact points between the heating element/pad (referred below, as the heating element) and the transport vessel, energy will not transfer efficiently from the heating elements to the vessel surface, resulting in increased heat losses and excessive power consumption. Further, the heating elements are susceptible to overheating and burn out at those locations for which contact between the heating element and the transport vessel is poor.

One of the most important parameters in the delivery of vapor phase gas from the transport vessel to the point-of-use is the flow rate. This operating parameter depends on the heat transfer to the liquefied gas in the transport vessel. As discussed above, the energy provided to the transport vessel in the form of heat requires to be carefully controlled to achieve a liquid boiling which is preferably of convective boiling regime. In this manner, the liquid droplets entrained in the vapor phase are minimized, and in turn the particulate impurities are substantially reduced.

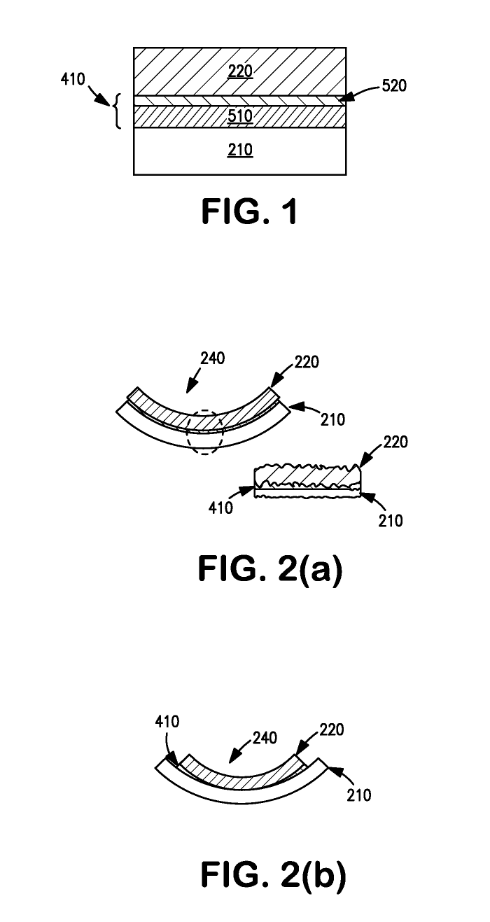

The present invention provides an energy delivery mechanism including a heating device which allows for optimal heat transfer to the transport vessel, and leads to improved gas delivery flow rates. With reference to FIG. 1, a schematic diagram of a transport vessel 220 with an external energy delivery device 210 is provided. Specifically, the thermal interface material 510 is employed as a filler material between heating element 210 and the transport vessel wall 220. The thermal interface material eliminates air gaps between the heater element 210 and the vessel wall 220. Moreover, the interface material fills the surface irregularities on the transport vessel wall 220 as well as the unmatched curvatures of the heating transport vessel wall 220 and the heating element 210. A non-adhesive material 520 can be employed between the transport vessel wall 220 and the thermal interface material to facilitate easy removal of the heater element upon change-out. The non-adhesive material 520 should be able to also conform to any surface irregularities on the transport vessel wall 220 upon pressure applied by the weight of the tank or alternatively by the mechanism which secures the heater element to the vessel wall. In addition, the non-adhesive material 520 should have good thermal conductivity so that its addition does not substantially increase the resistance to the heat transfer between the heater element 210 and the vessel wall 220.

Typically, the cylindrically configured transport vessel(s) are placed in a horizontal position at the manufacturer's site. The source of energy/heat is one or more energy delivery devices disposed on the lower portion of the transport vessel. The heating elements/pads are typically electrical resistance type heating means/elements typically selected from blanket heaters, heating bars, cables and coils, band heaters, heater tape and heating wires.

In the exemplified embodiment of FIG. 2(a), two layers of malleable or conformable materials (together 410) are placed between the heating element 210 which can be in solid phase and the vessel wall 220. The layer of thermal interface material 510 can have a high thermal conductivity and high surface tack in solid phase. As a result, this layer can fill air gaps between the surface of transport vessel 220 and the heating element 210 caused by surface irregularities and/or unmatching surface curvatures shown in FIG. 2(b). Minimizing the air gaps, layer 410 enhances the overall heat conduction to the transport vessel wall 220. The high surface tack enables layer 410 to be firmly attached to the heating elements without using any glue, which eliminates air gaps between this layer and the heating elements. Moreover, the thermal interface material does not undergo phase transition under the operating temperature and pressure of the bulk supply gas system (BSGS).

A second, thin and non-adhesive layer 520 (shown in FIG. 1) of the same or other material is placed on the container surface in solid phase. This non-adhesive layer will prevent the undesired adhesion of the thermal interface material 510 to the surface of the vessel, thereby allowing the change out of the heating element 210, or otherwise facilitates taking the transport vessel off line. Although the material contemplated is aluminum, foils of other material with same or larger thermal conductivity. The thickness of this layer can be in a range from 1 to 5 mils, preferably 2 to 3 mils, so long as the layer conforms to the irregularities and contour of the vessel wall. As the deformation of a thin shell/plate such as the non-adhesive layer 520 depends on the material thickness, an excessive thickness may lead to undesirable air gaps between the layer 520 and the vessel wall. The above mentioned range of thickness is appropriate for ton containers, which typically weigh a few hundred pounds. For a heavier vessel such as a drum or an ISO container, the thickness of the layer 520 can be increased accordingly.

In another exemplary embodiment, and with reference to co-pending U.S. Patent Application Publication No 2008/0000239A1, which is incorporated herein by reference in its entirety, the transport vessel is placed in a crescent-shaped substantially rigid cradle. The crescent-shaped cradle employs rigid steel heating pads. There can be one or more separate heating pads placed in each of the various zones on the lower part of the transport vessel. The heating pads are generally, cover a portion of the vessel surface, and the size is simply dictated by the type of transport vessel utilized and the number of heating pads used. The zones are independently controlled and provide energy to liquefied ammonia therein.

Pieces of silicon rubber thermal interface material with thermal conductive fillings are placed and centered onto the stainless steel heating pads. The silicon rubber material preferably has high surface tack so that it can stick non-permanently to the heating pads upon application of pressure, but without utilizing an adhesive such as glue. The material also has a hardness of 5 to 70, preferably 5-10 in Shore A scale so that it can conform to the curvature and irregularities of the heating pads and the container surfaces. The thickness of this silicon rubber material can be within the range of 15 to 1000 mils, the operating temperature can range from −54 to 200° C., and the thermal conductivity is in excess of 0.024 W/mK, preferably 1.6 W/mK or higher. The hardness range ensures that the material can conform to surface irregularities and curvatures at the pressure applied by the transport vessel. The thickness range and the thermal conductivity ensures that the overall heat resistance of the material is less than that of the air gaps prior to the application of this material. The operating temperature range ensures that the material does not undergo drastic physical or chemical changes under the operating temperature of the heating element.

Upon the application of the silicon rubber material to the heating pads, a thin layer of aluminum foil, or an equivalent thereof, can be applied to the top of the silicon rubber material. Due to the high surface tack of the silicon rubber material, the aluminum foil facilitates the easy removal of the heating element.

Various modifications can be made to the exemplary embodiments set forth above. For example, the heating element can be constructed on conformable material, such as silicon rubber, that has a higher hardness value than the thermal interface material. Additionally, the heating element can be constructed from a combination of one or more layers of rigid material such as stainless steel or ceramic, and one or more layers of conformable material such as silicon rubber. In certain configurations, the heating element can have a hardness value higher than that of the thermal interface material.

In another exemplary embodiment, the thermal interface material can be permanently attached to the heating element. Likewise, thermal interface material can be non-adhesive on either side, yet the side facing the heater element can be attached to this element with thermal conductive glue. Naturally, the operating temperature range of the glue should at least include the actual operating range of the heating element. Optionally, the hardness of the thermal interface material can range from 5 to 70 Shore A. It is recognized that the non-adhesive layer may not be necessary if the surface adhesion of the chosen thermal interface material is desirable or the thermal interface material is itself non-adhesive. It shall also be recognized that the energy delivery devices, even without the engagement of the thermal interface material or the non-adhesive layer, can be made removable and can be readily removed or replaced in the event of failure or degradation.

The energy delivery mechanism of the present invention will be further described in detail with reference to the following examples, which are, however to be construed as limiting the invention.

### EXAMPLES

The energy/heat transfer efficiency of the present invention was tested on ton-container-based bulk specialty gas supply systems to determine the vapor gas delivery flow rate.

In the example, a ton container filled with a mixture of liquid and vapor ammonia was placed horizontally on a crescent-shaped substantially rigid cradle, which employed rigid steel heating pads. The current invention was implemented as described in the detailed description of the invention above. The heat output from the heating pads was controlled and the temperatures and pressures were monitored at multiple locations of the system. During the experiment, the liquid ammonia was vaporized and the flow rate of the NH₃ vapor was measured. Implementing the current invention allowed the heat output from the heating pads to be increased to provide a higher vapor NH₃ flow rate, yet without raising the surface temperature of the container and the heating pads.

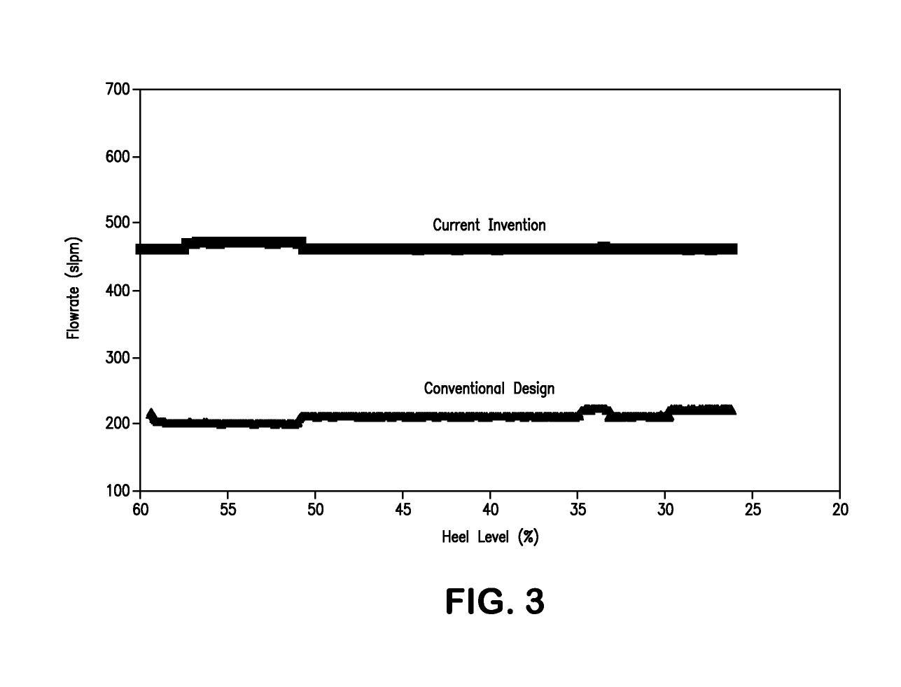

As demonstrated by experimental results, the supply gas delivery flow rate in the present invention increased by a factor of two or more. As shown in FIG. 3, the sustainable gas delivery flow rate, which is the flow rate at which the gas is delivered independent of the liquefied gas level (i.e., “heel” level), increased from 200 slpm to over 460 slpm.

While the invention has been described in detail with reference to exemplary embodiments thereof, it will become apparent to one skilled in the art that various changes and modifications can be made, and equivalents employed, without departing from the scope of the appended claims.

What is claimed is:

1. An energy delivery mechanism for a transport vessel utilized to convey vapor phase fluid at an elevated pressure, comprising:
at least one energy delivery device disposed on the lower portion of a transport vessel including a thin layer of a thermally conductive non-adhesive layer in contact with vessel wall, at least one heating element which substantially conforms to the contour of the vessel wall, and a thermal interface material disposed between the thermally conductive non-adhesive layer and the heating element, wherein said thermal interface material substantially fills the gaps between the unmatching configuration of the transport vessel and the heating element thereby providing substantially uniform energy to the transport vessel.

2. The energy delivery mechanism of claim 1, further comprising:
one or more substantially rigid support disposed on the outer periphery of the energy delivery device, wherein the support holds the energy delivery device in thermal contact with a lower portion of said transport vessel.

3. The energy delivery mechanism of claim 1, wherein the thermal interface material fills the imperfections in the transport wall.

4. The energy delivery mechanism of claim 1, wherein the transport vessel wall is a ton, drum or ISO container.

5. The energy delivery mechanism of claim 1, wherein the heating devices can easily be removed or changed without taking the transport vessel off-line.

6. The energy delivery mechanism of claim 1, wherein the heating element can be rigid of flexible.

7. The energy delivery mechanism of claim 1, wherein the heating element can be selected from the group consisting of blanket heaters, stainless steel heating pads, cables and coils, band heaters, heater tape, heating wires and combinations thereof.

8. The energy delivery mechanism of claim 1, wherein the thermal interface material is solid phase and has high thermal conductivity and high surface tack.

9. The energy delivery mechanism of claim 8, wherein the thermal interface material is a silicone rubber.

10. The energy delivery mechanism of claim 7, wherein the heating element is constructed from a combination of one or more layers of rigid and conformable material.

11. The energy delivery mechanism of claim 1, wherein thermally conductive non-adhesive layer is a foil material having a thickness ranging from about 1 to 5 mils.

12. An efficient energy delivery system adapted to various cylindrical transport vessels, comprising:
(a) a crescent-shaped substantially rigid cradle to accommodate a horizontally placed cylindrical transport vessel; and
(b) at least one energy delivery device disposed on the lower portion of said transport vessel including a thin layer of a thermally conductive non-adhesive layer in contact with vessel wall, a heating element which substantially conforms to the contour of the vessel wall, and a thermal interface material disposed between the thermally conductive non-adhesive layer and the heating element, wherein said thermal interface material substantially fills the gaps between the unmatching configuration of the transport vessel and the heating element thereby providing substantially uniform energy to the transport vessel.

13. The efficient energy delivery system of claim 12, wherein the system delivers gas in vapor phase at the point of use at a sustainable flow rate ranging from about 200 to 460 slpm.

14. An energy delivery mechanism for a transport vessel utilized to convey vapor phase fluid at an elevated pressure, comprising:
at least one energy delivery device disposed on the lower portion of a transport vessel including a at least one heating element which substantially conforms to the contour of the vessel wall, and a thermal interface material disposed between the transport vessel and the heating element, wherein said thermal interface material substantially fills the gaps between the unmatching configuration of the transport vessel and the heating element thereby providing substantially uniform energy to the transport vessel.
